(19) United States
(12) Patent Application Publication
(10) Pub. No.: US 2024/0054386 A1
(43) Pub. Date: Feb. 15, 2024

(54) CLIENT SELECTION IN OPEN RADIO ACCESS NETWORK FEDERATED LEARNING

(71) Applicant: Dell Products L.P., Round Rock, TX (US)

(72) Inventors: Ramy Atawia, Kanata (CA); Syed Shan-e-Raza Jaffry, Ottawa (CA)

(21) Appl. No.: 17/818,589

(22) Filed: Aug. 9, 2022

(51) Int. Cl. G06N 20/00

(52) U.S. Cl. CPC G06N 20/00

(57) ABSTRACT

A system can determine a first group of near-real time radio access network intelligent controllers (nRT-RICs) that satisfy a performance capability criterion. The system can determine, from the first group of nRT-RICs, a second group of nRT-RICs that satisfy a dissimilarity criterion, wherein the selected nRT-RICs are selected for a current round of federated learning of a machine learning model. The system can instruct the second group of nRT-RICs to perform federated learning of the machine learning model on respective second datasets. The system can, based on receiving respective indications of the respective local machine learning models, generate a global machine learning model. The system can send an indication of the global machine learning model to the nRT-RICs, wherein the nRT-RICs are configured to use the global machine learning model to predict a network performance metric of the open radio access network.

### BACKGROUND

An open radio access network (O-RAN) can generally comprise a broadband cellular communications network.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine a first group of near-real time radio access network intelligent controllers (nRT-RICs) of nRT-RICs of an open radio access network that satisfy a performance capability criterion. The system can determine, from the first group of nRT-RICs, a second group of nRT-RICs that satisfy a dissimilarity criterion, wherein the dissimilarity criterion identifies a dissimilarity between respective first datasets of respective first nRT-RICs of the first group of nRT-RICs and respective selected datasets of selected nRT-RICs of the nRT-RICs, wherein the selected nRT-RICs are selected for a current round of federated learning of a machine learning model. The system can instruct the second group of nRT-RICs to perform federated learning of the machine learning model on respective second datasets, to produce respective local machine learning models. The system can, based on receiving respective indications of the respective local machine learning models, generate a global machine learning model based on the respective indications of the respective local machine learning models. The system can send an indication of the global machine learning model to the nRT-RICs, wherein the nRT-RICs are configured to use the global machine learning model to predict a network performance metric of the open radio access network.

An example method can comprise determining, by a system comprising a processor, a first group of near-real time radio access network intelligent controllers (nRT-RICs) of nRT-RICs of a radio access network that satisfy a performance capability criterion. The method can further comprise determining, by the system and from the first group of nRT-RICs, a second group of nRT-RICs that satisfy a dissimilarity criterion, wherein the dissimilarity criterion identifies a dissimilarity between respective first datasets of respective first nRT-RICs of the first group of nRT-RICs and respective selected datasets of selected nRT-RICs of the nRT-RICs. The method can further comprise instructing, by the system, the second group of nRT-RICs to perform federated learning, to produce respective local machine learning models. The method can further comprise, based on receiving respective indications of the respective local machine learning models, generating, by the system, a global machine learning model.

An example non-transitory computer-readable medium can comprise instructions that, in response to execution, cause a system comprising a processor to perform operations. These operations can comprise determining a first group of agents from agents of a communications network that satisfy a performance capability criterion. The operations can further comprise determining, from the first group of agents, a second group of agents that satisfy a dissimilarity criterion based on respective metadata of respective agents of the first group of agents. The operations can further comprise instructing the second group of agents to perform federated learning, to produce respective local machine learning models. The operations can further comprise, based on receiving respective indications of the respective local machine learning models, generating a machine learning model based on the respective local machine learning models.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate client selection in open radio access network federated learning, in accordance with an embodiment of this disclosure;

FIG. 2 illustrates an example process flow that can facilitate client selection in open radio access network federated learning, in accordance with an embodiment of this disclosure;

FIG. 3 illustrates another example system architecture that can facilitate client selection in open radio access network federated learning, in accordance with an embodiment of this disclosure;

FIG. 4 illustrates an example signal flow that can facilitate client selection in open radio access network federated learning, in accordance with an embodiment of this disclosure;

FIG. 5 illustrates another example signal flow that can facilitate client selection in open radio access network federated learning, in accordance with an embodiment of this disclosure;

FIG. 6 illustrates another example process flow that can facilitate client selection in open radio access network federated learning, in accordance with an embodiment of this disclosure;

FIG. 7 illustrates another example process flow that can facilitate client selection in open radio access network federated learning, in accordance with an embodiment of this disclosure;

FIG. 8 illustrates another example process flow that can facilitate client selection in open radio access network federated learning, in accordance with an embodiment of this disclosure;

FIG. 9 illustrates another example process flow that can facilitate client selection in open radio access network federated learning, in accordance with an embodiment of this disclosure;

FIG. 10 illustrates another example process flow that can facilitate client selection in open radio access network federated learning, in accordance with an embodiment of this disclosure;

FIG. 11 illustrates another example process flow that can facilitate client selection in open radio access network federated learning, in accordance with an embodiment of this disclosure;

FIG. 12 illustrates another example process flow that can facilitate client selection in open radio access network federated learning, in accordance with an embodiment of this disclosure;

FIG. 13 illustrates another example process flow that can facilitate client selection in open radio access network federated learning, in accordance with an embodiment of this disclosure;

FIG. 14 illustrates another example process flow that can facilitate client selection in open radio access network federated learning, in accordance with an embodiment of this disclosure;

FIG. 15 illustrates another example process flow that can facilitate client selection in open radio access network federated learning, in accordance with an embodiment of this disclosure;

FIG. 16 illustrates an example block diagram of a computer operable to execute an embodiment of this disclosure.

### DETAILED DESCRIPTION

### Overview

The examples herein generally describe an Open Radio Access Network (ORAN) system architecture for broadband cellular communications. It can be appreciated that the present techniques can be applied more generally to other types of communications networks in which federated learning is performed.

An ORAN can comprise a disaggregated network that uses a RAN Intelligent Controller (RIC) for service automation, among other operations. In turn, a RIC can comprise a Non-Real-Time RIC (Non-RT-RIC) and multiple near-Real-time RIC (nRT-RIC), connected with each other via an A1 interface.

In general, a nRT RIC can provide fast control loop actions (e.g., 10 milliseconds (ms)-1,000 ms) that can improve network performance based on policies indicated by non-RT RIC. A Non-RT RIC can operate at a slower control loop (>1 seconds (s)) to tune policies based on network measurements.

For communicating between components in an ORAN, an A1 interface can connect an nRTC-RIC and a non-RT RIC for policy and key performance indicator (KPI) exchanges. An E2 interface can connect an nRTC-RIC with edge nodes such as a distributed unit (DU) and a central unit (CU). An O1 interface can comprise a management interface of a RIC, which can be terminated by a management and orchestration layer (SMO).

A non-RT-RIC can be part of a Service Management and Orchestration (SMO) entity. nRT-RICs can be connected to network edge devices (e.g. a gNodeB cellular communications base station, which can sometimes be referred to as a gNB) over an E2 interface. nRT-RICs can host relatively lesser computational and storage capabilities than a non-RT-RIC.

To implement network automation (e.g., automation based on machine learning (ML)) it can be that a global level policy is made at a Non-RT-RIC and shared with a nRT-RIC over an A1 interface. The nRT-RICs then make edge-level decision for E2 nodes.

The present techniques can be implemented to exploit a disintegrated RIC architecture and employ federated learning (FL) techniques, where nRT-RICs can be treated as FL-clients, and Non-RT-RICs can be treated as the FL-servers. A selection of FL-clients can be made on a nRT-RIC's processing and/or memory capabilities, and a variance in a dataset of ML input features.

Implementing the present techniques can facilitate expediting learning for a global model compared to random selection techniques that can be used in prior approaches. Implementing the present techniques can reduce a computational and signaling overhead, along with bounding the communication latency to low limits, compared with selecting all nRT-RICs as clients.

An O-RAN architecture can promote FL to distribute model training load across different network elements (which can be referred to as “clients;” e.g., near-RT RIC at different sites). A global model can be updated (e.g., at the non-RT RIC) based on local trained models and then shared across the clients to update their local model which can then be used for inference.

Due to the multivendor and generic hardware that can exist in an O-RAN deployment, the clients (nRT-RIC) can be expected to have different accuracies of locally trained models based on a size and granularity of the client's collected data (e.g., one client aggregates every 100 milliseconds (ms), while another client aggregates every 200 ms, as per vendor specific configuration); provide global model updates at different delays; and/or add additional layers of data transparency and security from edge nodes.

These challenges can result in delayed or inaccurate updates to a global ML model that can impact the network decisions (e.g., ML-based resource management and handover) and thus increases the risk of violating a user's quality of service (QoS) commitment.

In prior approaches, an O-RAN architecture can have a defined high-level flow (slogan level) between non-RT and near-RT RIC. It can be that no signaling detailed or agent selection technique is specified.

In prior approaches, FL can be performed with random client selection, where a single-vendor deployment is assumed (which can lead to less attention on a signaling structure between different nodes).

Some prior approaches can focus on optimizing global model accuracy and reducing communication latency, while using gradient norms of local devices to select clients that deliver model weights to a server. It can be that these prior approaches do not consider a signaling overhead required for an O-RAN-enabled FL model and a latency increase due to stated overheads.

Compared with previous approaches, implementing the present techniques can offer advantages. The present techniques can be implemented to minimize a local training cost by selecting a subset of near-RT RICs as clients (instead of all nRT-RICs as clients per O-RAN or a random-based selection in prior approaches). As a result, implementing the present techniques can result in faster global model learning and convergence by selecting a nRT-RIC with high processing capabilities; less overhead (computation and signaling) by avoiding redundant model updates from nRT-RICs with similar datasets; maintaining target inference accuracy (and hence higher RAN performance) by monitoring ML performance at non-client nRT-RICs, and triggering client selection or adapting the selection criteria to strike a balance between computation overhead and global model accuracy and/or an O-RAN compliant solution, and thus result in an applicability to multi-vendor deployments.

Implementing the present techniques can provide the following benefits. Federated learning can distribute a training load, and thus provide more deployment flexibility (e.g., among servers and a cloud with different processing capabilities in the same RAN deployment). The present techniques can provide for better usage of compute resources, such as by utilizing local memory and processing on RAN edge nodes, such as nRT-RICs. Via the present techniques, client selection can improve a global model accuracy and achieve better ML-based RAN optimization decisions.

It can be appreciated that the present techniques can be implemented more generally than in the specific examples described herein. In some examples, a ML throughput prediction model can be generalized to include other Medium Access Control (MAC) and physical (PHY) layer KPIs, such as block error rate (BLER), average channel quality indicator (CQI), rank indicator, reference signal received power (RSRP), reference signal received quality (RSRQ), number of scheduled users, and/or total number of transmitted bits.

Metadata can be generalized to include a type of traffic (e.g., configured quality of service (QoS) flow/fifth generation QoS indicator (5QI)); xApps (which can generally comprise containers that implement functions) target performance metrics and input KPIs; and/or served E2 nodes (e.g., a number and location of E2 nodes managed by each candidate nRT-RIC).

A system that implements the present techniques can extend to the following O-RAN compliant deployment:
nRT-RIC hosting the global model, E2 nodes (DU and CU) as clients. The client selection technique can be hosted by nRT-RIC, training can occur at E2 nodes, and signaling exchange can be performed over an E2 interface.
non-RT-RIC hosting the global model, E2 nodes (DU and CU) as clients. The client selection technique can be hosted by non-RT-RIC, training can occur at E2 nodes, and signaling exchange can be performed over an O1 interface.

### Example Architectures, Process Flows, and Signal Flows

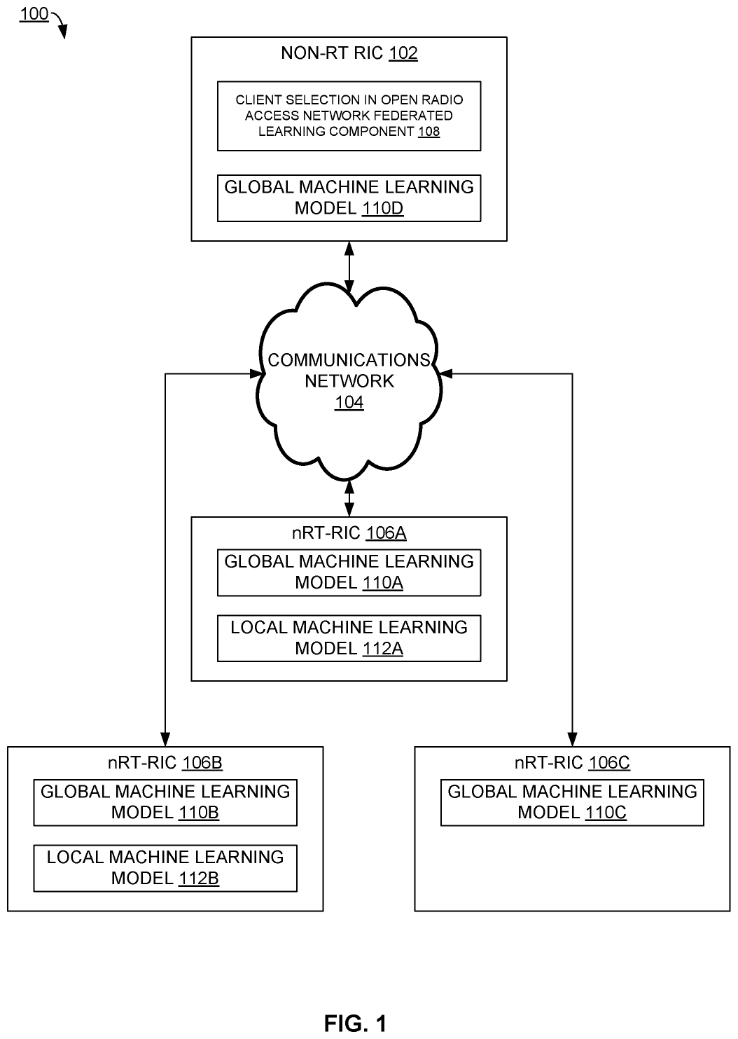

FIG. 1 illustrates an example system architecture 100 that can facilitate client selection in open radio access network federated learning, in accordance with an embodiment of this disclosure.

System architecture 100 can generally comprise an O-RAN architecture. System architecture 100 comprises non-RT RIC 102, communications network 104, nRT-RIC 106A, nRT-RIC 106B, and nRT-RIC 106C. In turn, non-RT RIC 102 comprises client selection in open radio access network federated learning component 108 and global machine learning (ML) model 110D. nRT-RIC 106A comprises global ML model 110A and local ML model 112A. nRT-RIC 106B comprises global ML model 110B and local ML model 112B. nRT-RIC 106C comprises global ML model 110C.

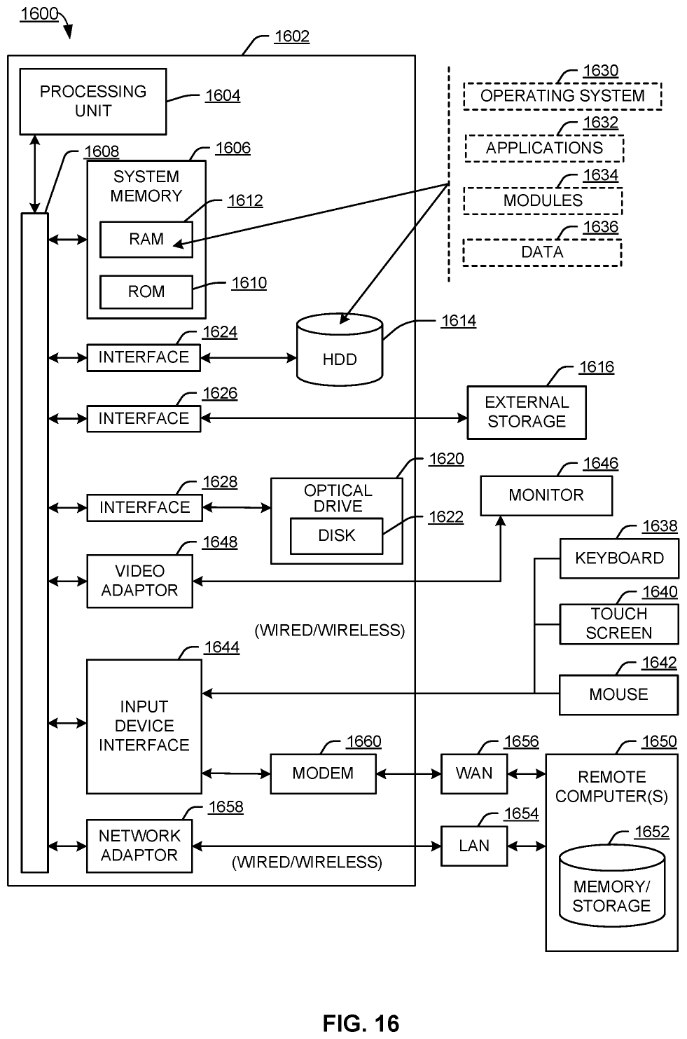

Each of block non-RT RIC 102, communications network 104, nRT-RIC 106A, nRT-RIC 106B, and/or nRT-RIC 106C can be implemented with part(s) of computing environment 1600 of FIG. 16. Communications network 104 can comprise a computer communications network, such as the Internet.

Client selection in open radio access network federated learning component 108 can determine which nRT-RICs to have perform federated learning on a ML model. Client selection in open radio access network federated learning component 108 can first select nRT-RICs that have a current capacity to perform federated learning. Client selection in open radio access network federated learning component 108 can then select from those initially selected nRT-RICs those nRT-RICs that will perform the federated learning, based on those again selected nRT-RICs having sufficiently different datasets from each other (to avoid locally training models with redundant data).

The nRT-RICs can provide client selection in open radio access network federated learning component 108 with metadata about their datasets rather than the datasets themselves to preserve privacy.

As depicted, client selection in open radio access network federated learning component 108 has selected nRT-RIC 106A and nRT-RIC 106B to perform federated learning (they have local ML model 112A and local ML model 112B, respectively). Client selection in open radio access network federated learning component 108 can receive these local models and from them generate global ML model 110D. Client selection in open radio access network federated learning component 108 can distribute a copy of this global ML model to each nRT-RIC (here, global ML model 110A, global ML model 110B, and global ML model 110C, respectively). A nRT-RIC that was not selected for federated learning (e.g., nRT-RIC 106C) can still receive a copy of the global ML model generated based on the federated learning (global ML model 110C).

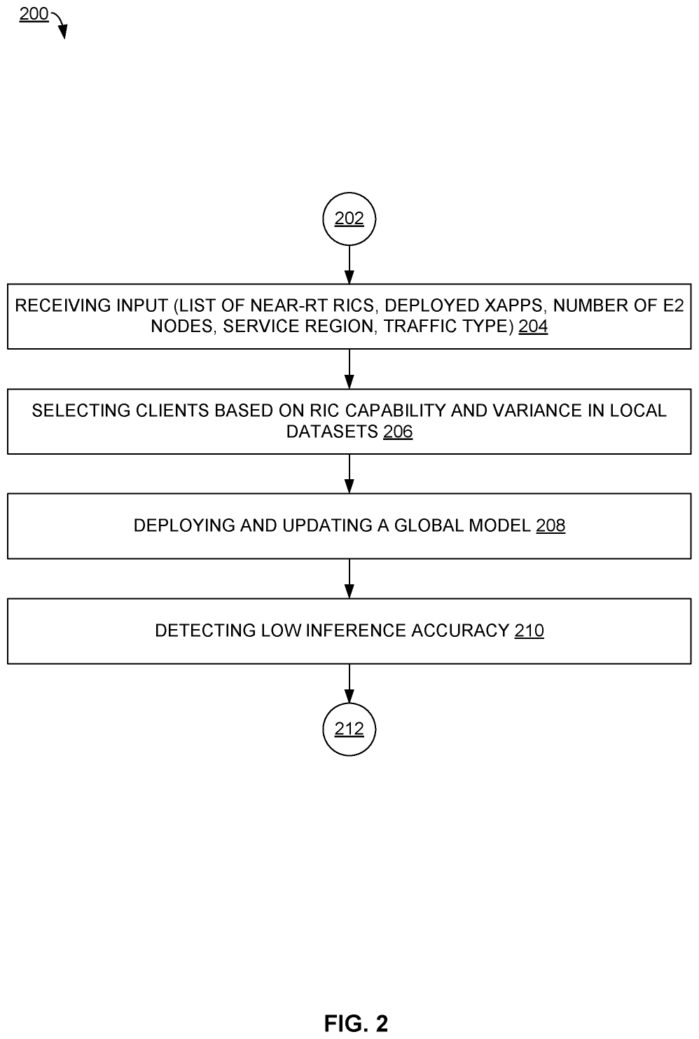

In some examples, client selection in open radio access network federated learning component 108 can implement part(s) of the process flows of FIGS. 2 and 6-14 to implement client selection in open radio access network federated learning.

It can be appreciated that system architecture 100 is one example system architecture for client selection in open radio access network federated learning, and that there can be other system architectures that facilitate client selection in open radio access network federated learning, such as those with more or fewer nRT-RICs than are depicted in system architecture 100.

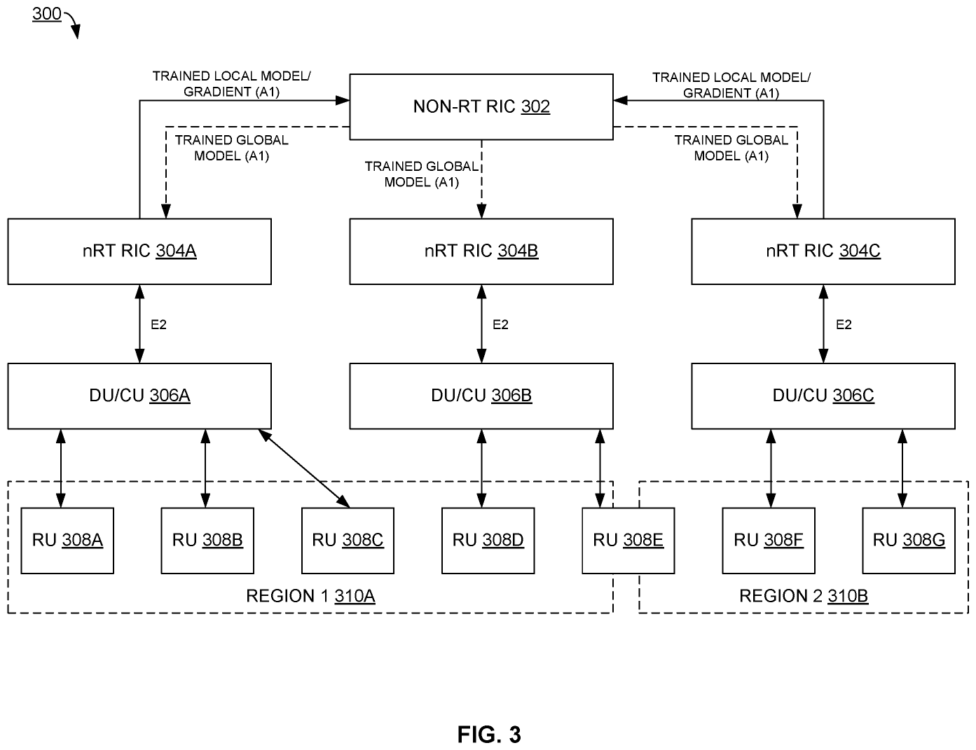

FIG. 2 illustrates an example process flow 200 that can facilitate client selection in open radio access network federated learning, in accordance with an embodiment of this disclosure. In some examples, one or more embodiments of process flow 200 can be implemented by client selection in open radio access network federated learning component 108 of FIG. 1, non-RT RIC 302 of FIG. 3, and/or computing environment 1600 of FIG. 16.

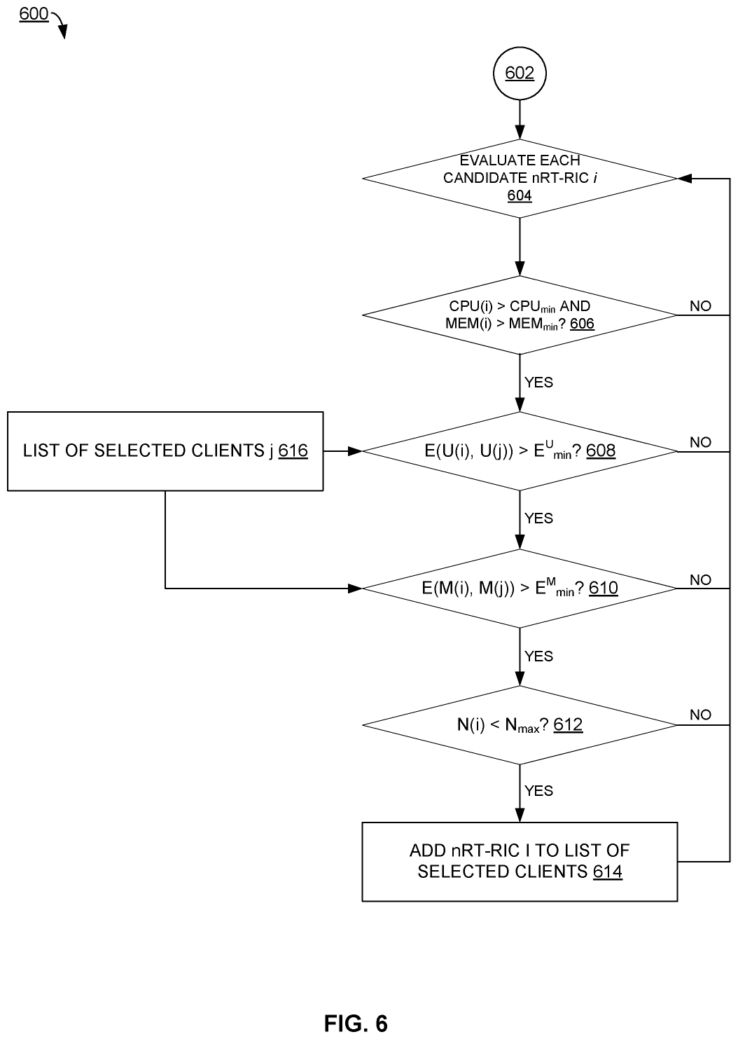

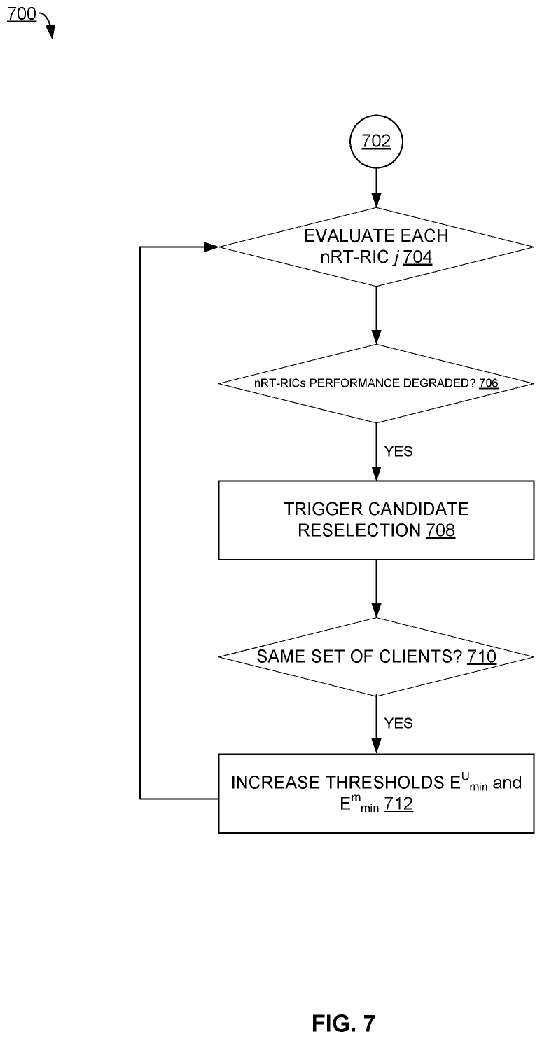

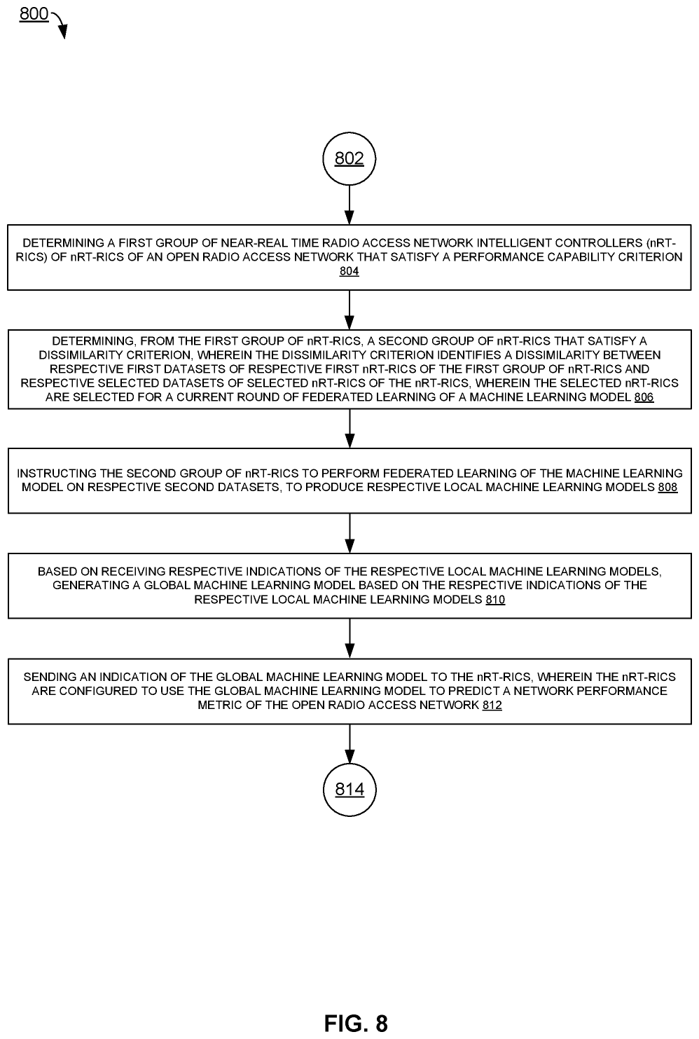

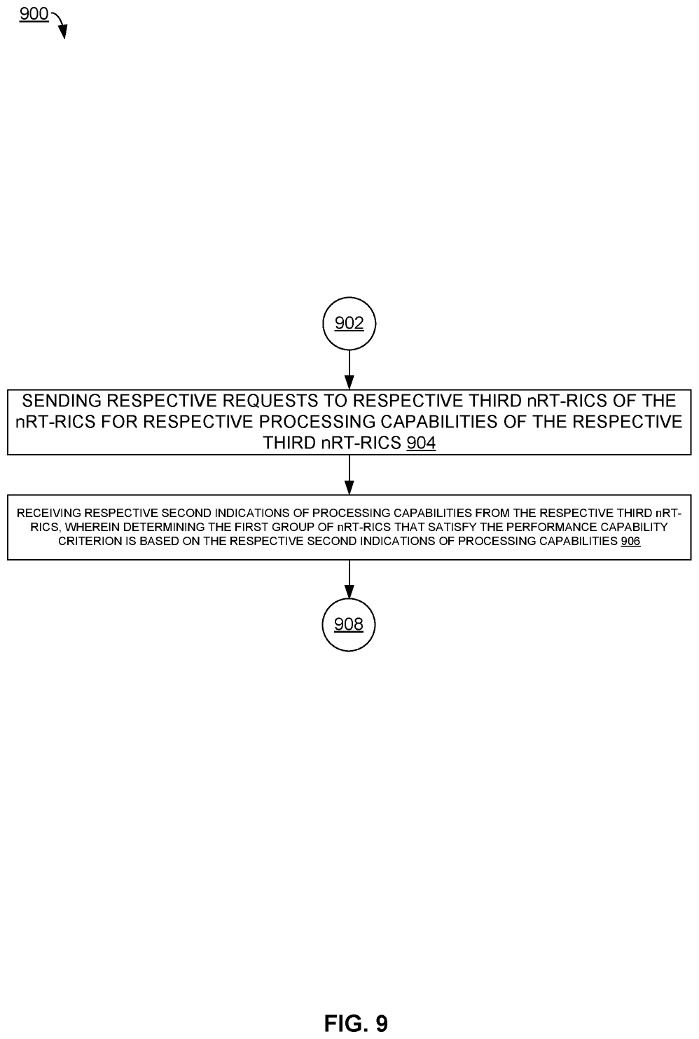

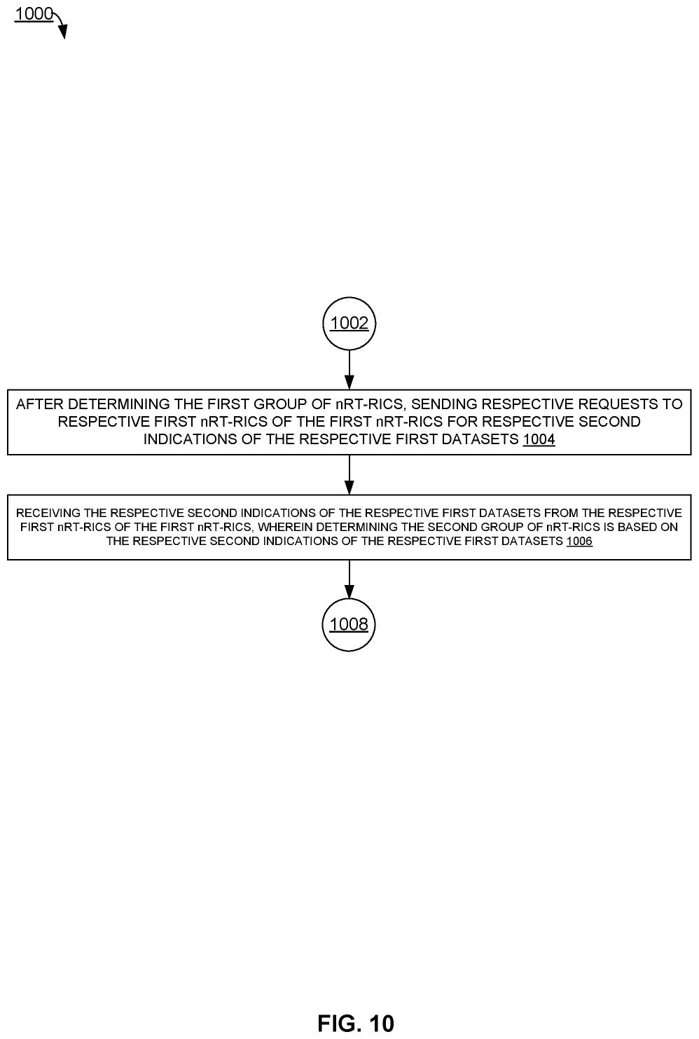

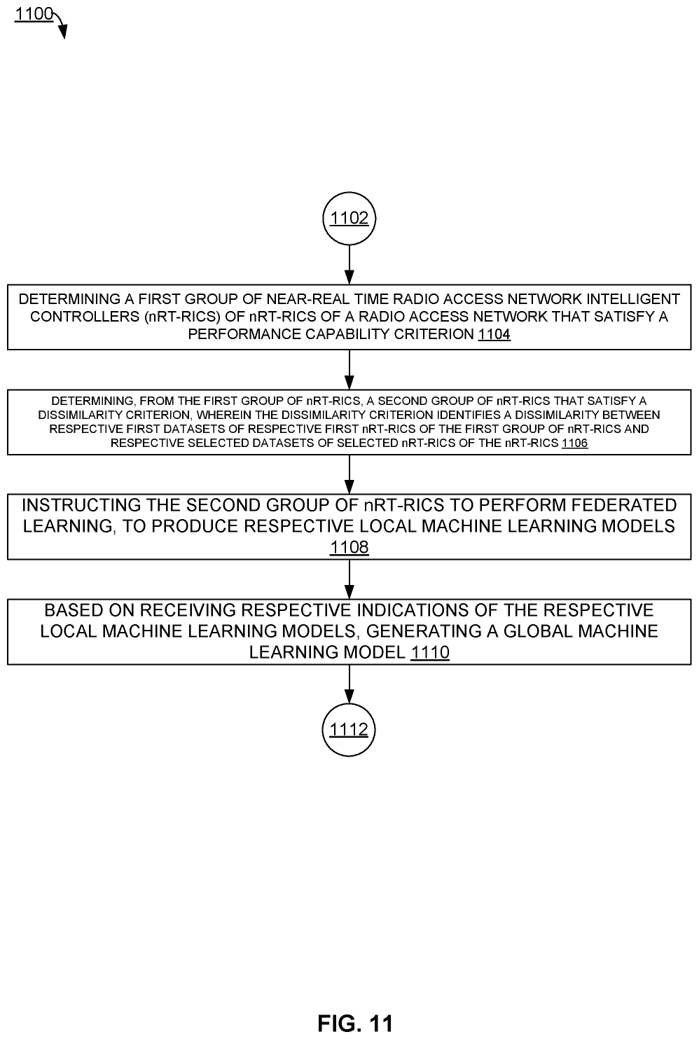

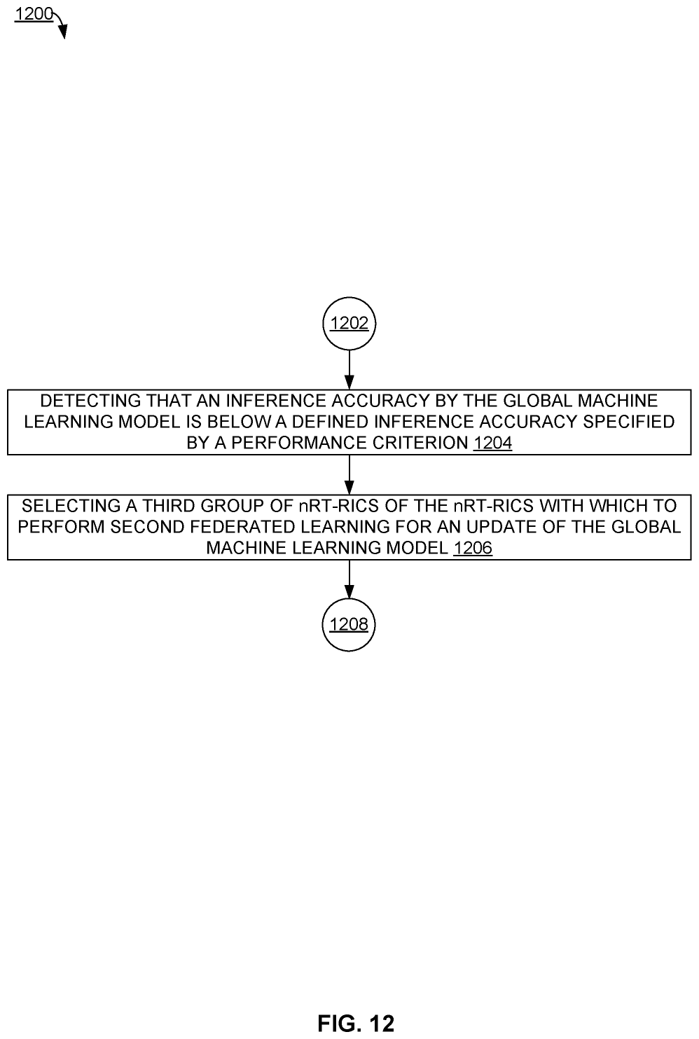

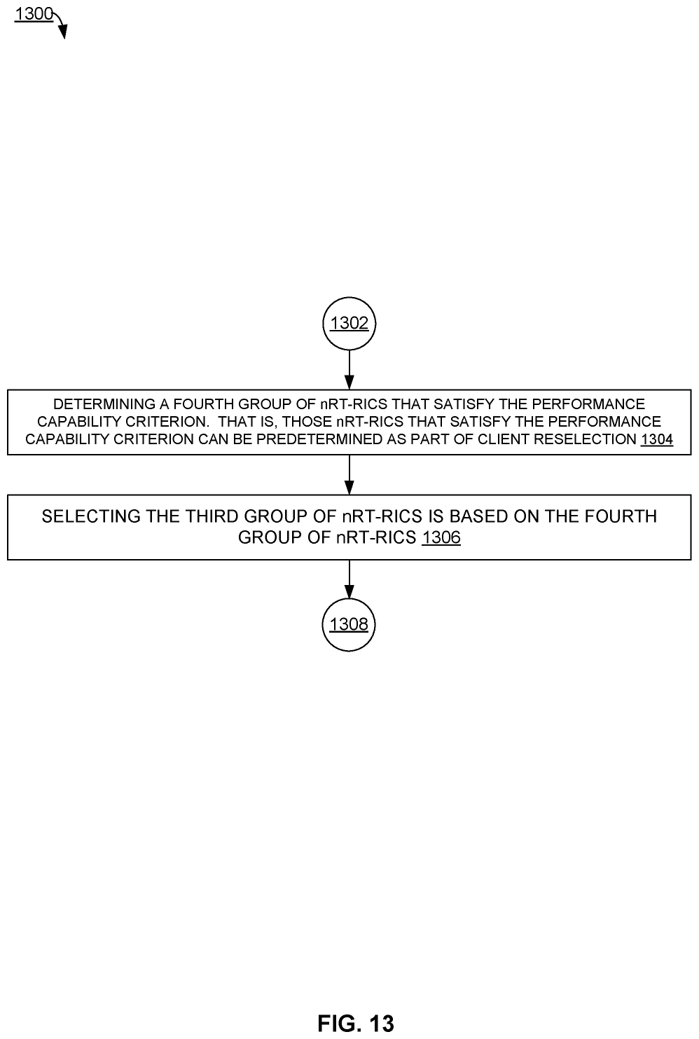

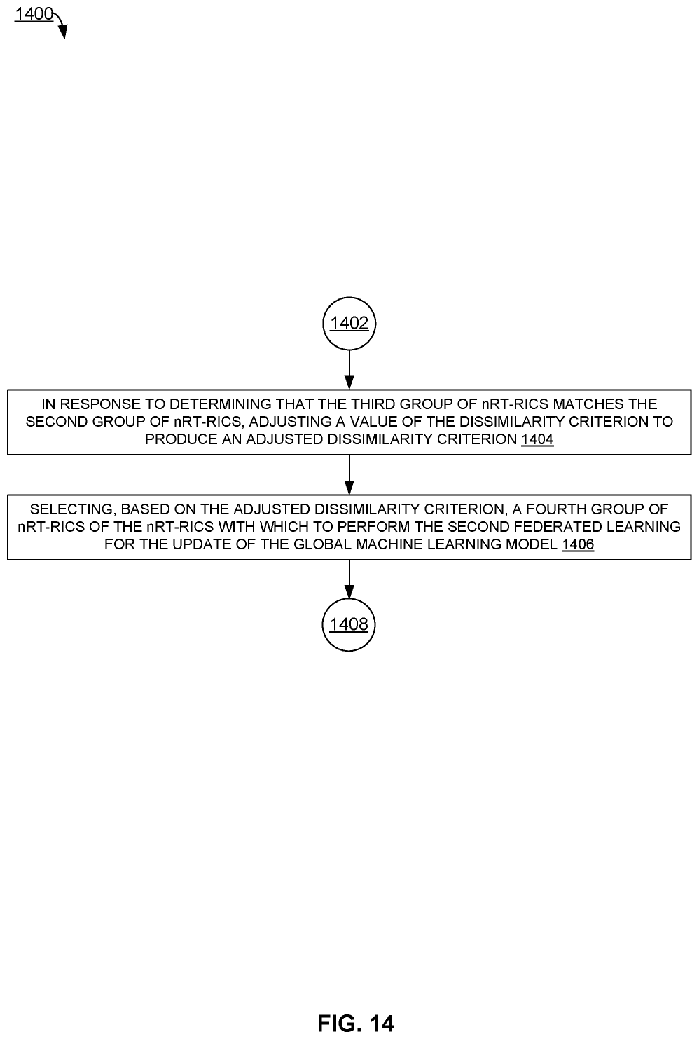

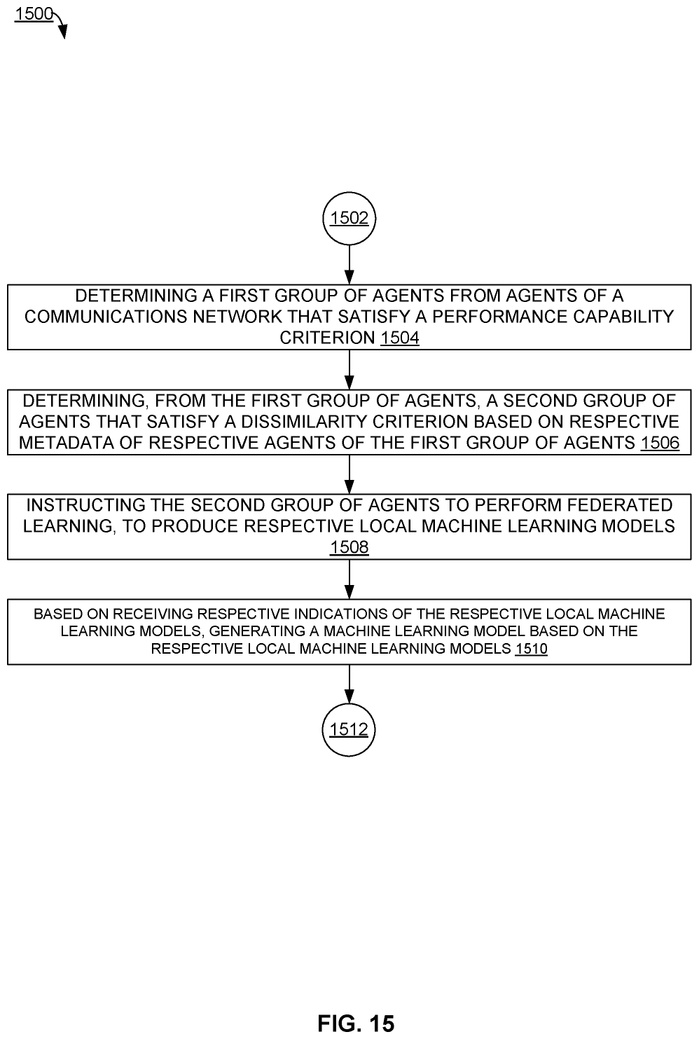

It can be appreciated that the operating procedures of process flow 200 are example operating procedures, and that there can be embodiments that implement more or fewer operating procedures than are depicted, or that implement the depicted operating procedures in a different order than as depicted. In some examples, process flow 200 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1100 of FIG. 11, process flow 1200 of FIG. 12, process flow 1300 of FIG. 13, process flow 1400 of FIG. 14, and/or process flow 1500 of FIG. 15.

Process flow 200 starts with 202 and moves to operation 204.

Operation 204 depicts receiving input. This input can comprise a list of near-RT RICs, deployed xApps, a number of E2 nodes, a service region, and/or a traffic type.

After operation 204, process flow 200 moves to operation 206.

Operation 206 depicts selecting clients based on RIC capability and variance in local datasets (which can be based on feature KPI metadata). In some examples, operation 206 can comprise performing client configuration over an A1 interface.

After operation 206, process flow 200 moves to operation 208.

Operation 208 depicts deploying and updating a global model.

After operation 208, process flow 200 moves to operation 210.

Operation 210 depicts detecting low inference accuracy. In some examples, detecting low inference accuracy can trigger a reselection of clients over the A1 interface.

After operation 210, process flow returns to operation 206. In this manner, selecting clients for federated learning and updating the global model can be iteratively performed when it is determined that accuracy is insufficient.

The present techniques can be implemented to select a subset of nRT-RICs as local training clients for federated learning based on criteria such as processing and memory resources of the machines/servers hosting the nRT-RIC. This can account also for processing load due to hosting delay sensitive xApps or serving a large number of E2 nodes (which can comprise a central unit (CU) and a distributed unit (DU) of a radio). Another criterion can include a variance in a local dataset collected by nRT-RICs; this can avoid model underfitting and redundant model updates from correlated nRT-RICs. This can be done through comparing the metadata of key performance indicators (KPIs) collected at candidate clients.

The present techniques can be implemented to detect degradations in global model performance (e.g., a high inference error at a nRT-RIC), and then perform client reselection (which could exclude nRT-RICs previously selected as clients and/or add new clients); or adapt client reselection thresholds).

The present techniques can be implemented to extend an O-RAN standardized A1 interface for all needed signaling between a nRT-RIC and a non-RT-RIC during client selection and retraining without violating the privacy of clients.

FIG. 3 illustrates another example system architecture 300 that can facilitate client selection in open radio access network federated learning, in accordance with an embodiment of this disclosure. In some examples, part(s) of system architecture 300 can be used to implement part(s) of system architecture 100 of FIG. 1.

System architecture 300 comprises non-RT RIC 302, nRT-RIC 304A, nRT-RIC 304B, nRT-RIC 304C, DU/CU 306A, DU/CU 306B, DU/CD 306C, radio unit (RU) 308A, RU 308B, RU 308C, RU 308D, RU 308E, RU 308F, RU 308G, region 1 308A, and region 2 308B.

Non-RT RIC 302 can be similar to non-RT RIC 102 of FIG. 1. nRT-RIC 304A, nRT-RIC 304B, and nRT-RIC 304C can each be similar to one or more of nRT-RIC 106A, nRT-RIC 106B, and/or nRT-RIC 106C. DU/CU 306A, DU/CU 306B, and DU/CU 306C can each comprise a DU and a CU of a radio. A DU can generally be configured to handle real time level 1 (L1) and level 2 (L2) scheduling functions of a radio. A CU can generally be configured to handle non-real time, higher L2 and level 3 (L3) scheduling functions of a radio. A DU and a CU can combine to form a gNB of a radio.

RU 308A, RU 308B, RU 308C, RU 308D, RU 308E, RU 308F, RU 308G can each comprise a radio unit of a radio. A radio unit can generally be configured to handle digital front end (DFE) functions, parts of the PHY layer, and beamforming functions. In some examples, one DU/CU can correspond to multiple RUs.

RUs can be divided into logical regions, here region 1 310A and region 2 310B. As depicted, each RU is a member of one region, except RU 308E, which is a member of both region 1 310A and region 2 310B. A region can comprise a geographical area where network traffic experienced by nodes (e.g., RUs, DUs, and/or nRT-RICs) is of a similar distribution and/or type. For example, in FIG. 3, region 1 310A and region 2 310B can experience different type of nodes. An example of this can be that region 1 310A is a business district with heavy traffic during weekdays and light traffic during weekends, while region 2 310B is a residential area with light traffic during weekdays and heavy traffic during weekends.

As depicted Non-RT RIC 302 can communicate with each nRT-RIC via an A1 interface. Non-RT RIC 302 can direct nRT-RIC 304A and nRT-RIC 304B to perform federated learning to produce a trained local model/gradient (or weights of a machine learning model), and report those back. Non-RT RIC 302 can use these multiple local models to produce a trained global model and provide the trained global model to each nRT-RIC, including nRT-RIC 304B, which did not produce its own trained local model/gradient.

Each of nRT-RIC 304A, nRT-RIC 304B, and nRT-RIC 304C can have different processing capabilities, and this information can be used by non-RT RIC 302 in deciding which nRT-RICs to have perform federated learning. Additionally, each of nRT-RIC can have different datasets (based on which RUs they are communicatively coupled to), and this dataset information can be used by non-RT RIC 302 in deciding which nRT-RICs to have perform federated learning. It can be that non-RT RIC 302 selects nRT-RICs that have dissimilar datasets so that local models are trained with dissimilar datasets, and then a global model will be more robust, as it corresponds to a greater diversity of training data.

A system according to the present techniques can comprise a non-RT RIC, such as non-RT RIC 302. A non-RT RIC can host a global ML model; select FL clients (e.g., nRT-RIC 304A and nRT-RIC 304B) for local model training; receive model updates from selected FL clients; and update the model and sends the global model to all nRT-RICs.

Such a system can also comprise one or more nRT-RICs. A nRT-RIC can report its processing capability and metadata to the non-RT RIC; if selected as an FL client, a nRT-RIC can perform local training for the model and sends updated model to the non-RT RIC; and can deploy the general ML model and use it for inference.

In an example, nRT-RIC 304A can be selected for region 1 310A model training since it has higher processing capability than nRT-RIC 304B. nRT-RIC 304A and nRT-RIC 304B can be expected to have similar datasets due to serving a same region (e.g., have spatial-correlation/similarity), and thus similar model updates. Then, nRT-RIC 304C can be selected, despite its low processing capabilities, to perform local training since it is the only representative of region 2 310B (e.g., it has no spatial correlation with nRT-RICs of region 1 310A).

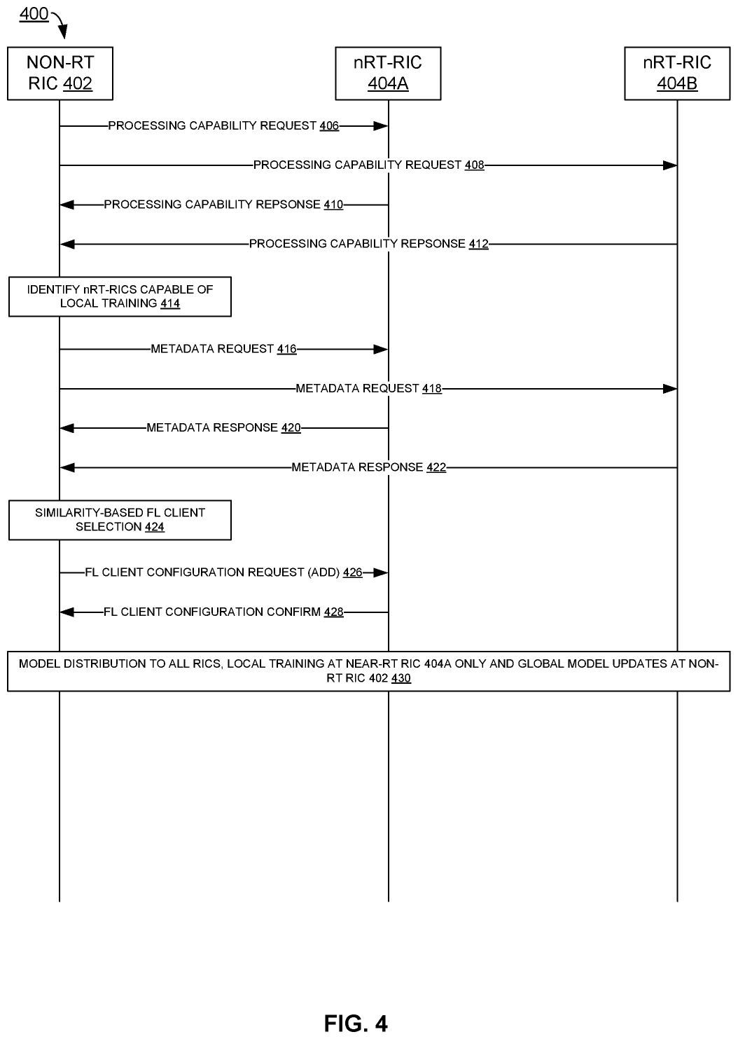

FIG. 4 illustrates an example signal flow 400 that can facilitate client selection in open radio access network federated learning, in accordance with an embodiment of this disclosure. In some examples, part(s) of signal flow can be implemented with part(s) of system architecture 100 of FIG. 1, and/or parts of system architecture 300 of FIG. 3.

Signal flow 400 comprises non-RT RIC 402 (which can be similar to non-RT RIC 102 of FIG. 1); nRT-RIC 504A (which can be similar to nRT-RIC 106A); and nRT-RIC 504B (which can be similar to nRT-RIC 106B).

Non-RT RIC 402 sends processing capability request 406 to nRT-RIC 404A. Non-RT RIC 402 also sends processing capability request 408 to nRT-RIC 404B.

Non-RT RIC 402 receives processing capability response 410 from nRT-RIC 404A, in response to 406. Non-RT RIC 402 also receives processing capability response 412 from nRT-RIC 404B, in response to 408. A processing capability response can indicate information about the corresponding nRT-RIC, such as available central processing unit (CPU) resources, or an amount of memory that the nRT-RIC possesses and/or has available for local model training.

Based on 410 and 412, at 414 non-RT RIC 402 identifies nRT-RICs capable of local training.

For the nRT-RICs identified in 414, non-RT RIC 402 sends a metadata request to those nRT-RICs (here, nRT-RIC 404A and nRT-RIC 404B). Non-RT RIC 402 sends metadata request 416 to nRT-RIC 404A. Non-RT RIC 402 also sends metadata request 418 to nRT-RIC 404B.

Non-RT RIC 402 receives metadata response 420 from nRT-RIC 404A, in response to 416. Non-RT RIC 402 also receives metadata response 422 from nRT-RIC 404B, in response to 418. A metadata response can comprise KPI statistical information.

Based on 420 and 422, at 424 non-RT RIC 402 identifies nRT-RICs to perform FL based on similarity-based FL client selection. Here, non-RT RIC 402 identifies nRT-RIC 404A for this purpose.

non-RT RIC 402 then sends nRT-RIC 404A FL client configuration request (add) 426. In response, non-RT RIC 402 receives from nRT-RIC 404A FL client configuration confirm 428.

At 430, there is model distribution to all RICs, local training of the model at nRT-RIC 404A, and global model updates at non-RT RIC 402.

Signal flow 400 illustrates a capability and metadata exchange between non-RT RIC 402 and near-RT RICs 404A and 404B, over an O-RAN A1 interface. Metadata can include statistics about local dataset that helps non-RT RIC 402 identify nRT-RICs with similar datasets (e.g., due to serving the same region). Metadata can include collected KPIs, such as name (e.g., throughput, retainability), granularity, and statistical values (e.g., mean, standard deviation, minimum, maximum, median, etc.).

Non-RT RIC 402 can perform capability and similarity-based FL client selection prior to model distribution.

In this example, only nRT-RIC 404A will be selected as a client (e.g., similar metadata to nRT-RIC 404B). In this example, all other near-RT RICs still receive the global ML model and use it for inference.

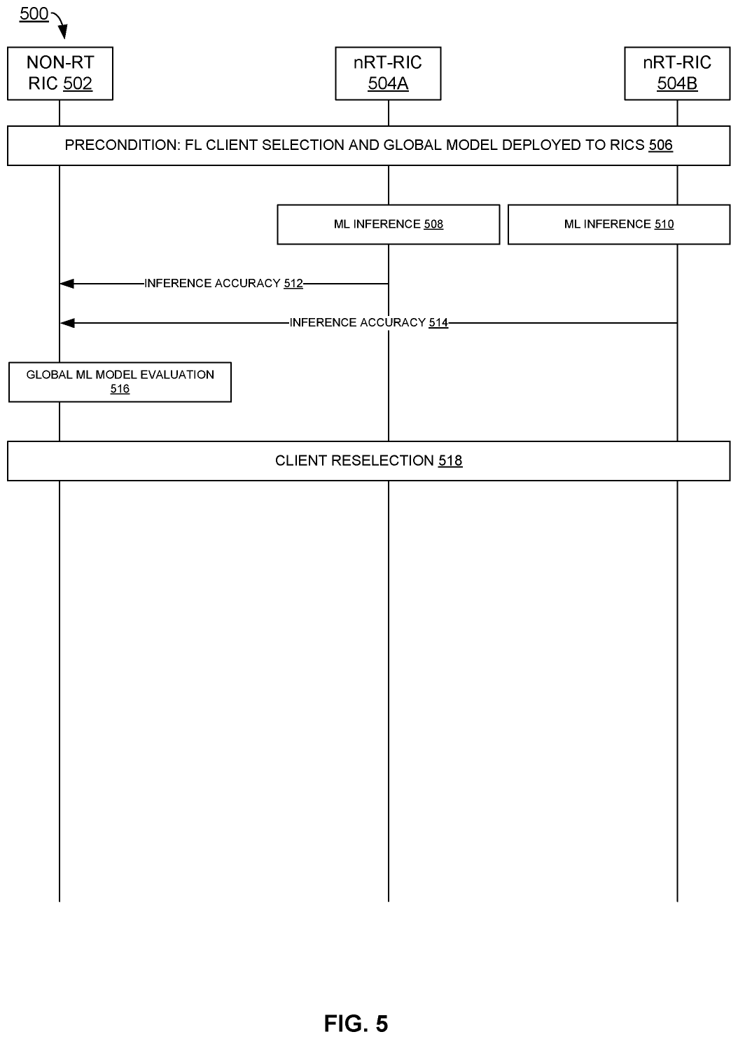

FIG. 5 illustrates another example signal flow 500 that can facilitate client selection in open radio access network federated learning, in accordance with an embodiment of this disclosure. In some examples, part(s) of signal flow can be implemented with part(s) of system architecture 100 of FIG. 1, and/or parts of system architecture 300 of FIG. 3.

Signal flow 500 comprises non-RT RIC 502 (which can be similar to non-RT RIC 402 of FIG. 4); nRT-RIC 504A (which can be similar to nRT-RIC 404A); and nRT-RIC 504B (which can be similar to nRT-RIC 404B).

506 illustrates that FL client selection has been performed, and a global model deployed to the nRT-RICs (such as by implementing signal flow 400 of FIG. 4). At 508, nRT-RIC 504A performs inferences with its copy of the global model. Similarly, at 510, 508, nRT-RIC 504B. performs inferences with its copy of the global model.

Non-RT RIC 502 receives inference accuracy 512 from nRT-RIC 504A. This inference accuracy can indicate an accuracy of nRT-RIC 504A using its copy of the global model, and can be expressed as a measurement of root mean square error (RMSE). In other examples, other forms of measure of difference can be used instead of, or in addition to, RMSE, such as mean squared error (MSE), or mean absolute percentage error (MAPE). Similarly, non-RT RIC 502 receives inference accuracy 514 from nRT-RIC 504B.

Based on this inference accuracy information (e.g., they indicate RMSE values above a predetermined threshold value), non-RT RIC 502 re-evaluates the global model 516. Then, non-RT RIC 502 re-selects clients 518 to perform FL of the model.

This signaling diagram illustrates all nRT-RICs adopting a global ML model will report their inference accuracy (e.g., RMSE). In this example, non-RT RIC 502 can check if the inference accuracy is low (e.g., high RMSE) and can trigger client reselection.

Client reselection can check for the following: a metadata similarity between non-client nRT-RICs with low accuracy and the client nRT-RIC; and/or if the metadata similarity is changed significantly (e.g., beyond a defined threshold amount of change), then the initial selection procedure to select clients (e.g., nRT-RICs) that are capable of performing local machine learning model training can be triggered, or the similarity thresholds can be adapted.

An example of similarity can be a Euclidian distance as described herein.

FIG. 6 illustrates another example process flow that can facilitate client selection in open radio access network federated learning, in accordance with an embodiment of this disclosure. In some examples, one or more embodiments of process flow 600 can be implemented by client selection in open radio access network federated learning component 108 of FIG. 1, non-RT RIC 302 of FIG. 3, and/or computing environment 1600 of FIG. 16.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 200 of FIG. 2, process flow 700 of FIG. 7, process flow 800 of FIG. 8, process flow 900 of FIG. 9, process flow 1000 of FIG. 10, process flow 1100 of FIG. 11, process flow 1200 of FIG. 12, process flow 1300 of FIG. 13, process flow 1400 of FIG. 14, and/or process flow 1500 of FIG. 15.

Process flow 600 begins with 602, and moves to operation 604.

Operation 604 depicts evaluating each candidate nRT-RIC i with the following operations.

After operation 604, process flow 600 moves to operation 606. Operation 606 depicts determining whether CPU(i)>CPUₘᵢₙ AND MEM(i)>MEMₘᵢₙ. That is, a determination is made as to whether the candidate nRT-RIC i has sufficient processing capabilities to be considered for federated learning. This can comprise determining whether nRT-RIC i has sufficient processors (CPU) and memory (MEM) that are each above a minimum threshold value.

Where in operation 606, it is determined that candidate nRT-RIC i has sufficient processing capabilities to be considered for federated learning, process flow 600 moves to operation 608. Instead, where in operation 606, it is determined that candidate nRT-RIC i lacks sufficient processing capabilities to be considered for federated learning, process flow 600 returns to operation 604, where another candidate nRT-RIC can be selected and evaluated.

Operation 608 is reached from operation 606 where it is determined in operation 606 that candidate nRT-RIC i has sufficient processing capabilities to be considered for federated learning. Operation 608 depicts determining whether candidate nRT-RIC i has a dissimilarity value relative to already-selected clients that is above a minimum threshold. This can evaluate PRB utilization (U) for all connected DUs to candidate nRT-RIC i relative to each already-selected client, and can be performed based on a Euclidian distance (E).

At operation 616, a list of already-selected clients j can be provided to the evaluation in operation 608.

Where in operation 608 it is determined that candidate nRT-RIC i has a dissimilarity value relative to each already-selected client that is above a minimum threshold, process flow 600 moves to operation 610. Instead, where in operation 608 it is determined that candidate nRT-RIC i lacks a dissimilarity value relative to each already-selected client that is above a minimum threshold, process flow 600 returns to operation 604, where another candidate nRT-RIC can be selected and evaluated.

Operation 610 is reached from operation 608 where it is determined in operation 608 that candidate nRT-RIC i has a dissimilarity value relative to each already-selected client that is above a minimum threshold. Operation 610 depicts determining whether candidate nRT-RIC i has a dissimilarity value relative to already-selected clients that is above a minimum threshold. This can evaluate average MCS (M) for all scheduled users in connected DUs to candidate nRT-RIC i relative to each already-selected client, and can be performed based on a Euclidian distance (E).

At operation 616, a list of already-selected clients j can be provided to the evaluation in operation 610.

Where in operation 610 it is determined that candidate nRT-RIC i has a dissimilarity value relative to each already-selected client that is above a minimum threshold, process flow 600 moves to operation 612. Instead, where in operation 610 it is determined that candidate nRT-RIC i lacks a dissimilarity value relative to each already-selected client that is above a minimum threshold, process flow 600 returns to operation 604, where another candidate nRT-RIC can be selected and evaluated.

Operation 612 is reached from operation 610 where it is determined in operation 610 that candidate nRT-RIC i has a dissimilarity value relative to each already-selected client that is above a minimum threshold. Operation 612 depicts determining whether the maximum number of mobile devices being served by nRT-RIC i has been reached. This can be a maximum number of mobile outliers being served for the purposes of selecting a nRT-RIC for federated learning, rather than a maximum number of clients that the nRT-RIC is capable of serving. This can be performed to avoid selecting a nRT-RIC that serves a very large number of users to avoid outliers.

Where in operation 612 it is determined that the maximum number of mobile devices being served has not been reached, process flow 600 moves to operation 614. Instead, where in operation 612 it is determined that the maximum number of mobile devices being served has been reached, process flow 600 returns to operation 604, where another candidate nRT-RIC can be selected and evaluated.

Operation 614 is reached from operation 612 where it is determined that the maximum number of clients for federated learning has not been reached. Operation 614 depicts adding candidate nRT-RIC i to a list of selected clients (such as the list maintained as part of operation 616). After operation 614, process flow 600 returns to operation 604, where another candidate nRT-RIC can be selected and evaluated.

The following can be implemented to facilitate ML-based throughput prediction. A ML model can comprise a deep neural network. Its input features can comprise physical resource block (PRB) utilization (U): the total number of PRBs used for downlink (DL) scheduling divided by the total available PRBs. The input features can also comprise modulation and coding scheme (MCS): This can comprise an index of modulation and coding used for DL data transmission, e.g., physical downlink shared channel (PDSCH) (which can vary from 0 to 28 based on channel conditions).

An output feature of the ML model can be a mean user equipment (UE) throughput (Thpt): the total number of bits transmitted over the air to the UE divided by the total duration of time slots with data transmitted over the air.

With regard to a nRT-RIC, a processing capability can comprise central processing unit (CPU) processing capabilities (in gigahertz (GHz)), and/or memory capabilities (in gigabytes (GB) or petabytes (PB)). Let L_{T}^{CPU,n}, L_{A}^{CPU,n}, L_{C}^{CPU,n} be total, available, and locally consumed CPU resources in nRT-RIC n, respectively. L_{R}^{CPU} can be the required processing per bit for the task distributed by Non-RT-RIC, which is a decision that could be made on L_{A}.

Let L_{T}^{mem,n}, L_{A}^{mem,n}, L_{C}^{mem,n} be the total, available, and locally consumed memory resources, in nRT_RIC n respectively. L_{R}^{mem} can be the memory required for the task distributed by Non-RT-RIC, a decision could be made on L_{A}. A decision to select nRT-RIC n can be a function of these parameters—e.g., ƒ(L_{T}^{X,n}, L_{A}^{X,n}, L_{C}^{X,n}, L_{R}^{X,n}), where X∈{CPU, mem (memory)}

Metadata can comprise statistics on each input feature: min, max and median. For PRB utilization (U) this can be {Uₘᵢₙ, Uₘₐₓ, U_{median}} for all connected DUs to the nRT-RIC. For MCS this can be M_{avg}, which can be an average (MCS) for all scheduled users in connected DUs.

Metadata can further comprise an average number of scheduled users per transmission time interval (TTI)→N. A TTI can comprise a smallest granularity for which a cellular network assigns resources to user over the air. In other words, a base station can schedule users for each TTI. N can represent an average number of users per TTI. Here, the metadata can include information about how many users (on average) an nRT-RIC serves per TTI.

Candidate nRT-RICs can be selected as clients where they satisfy the following.

With respect to processing capabilities, candidate nRT-RICs can be selected where
CPU (L_{A}^{CPU,n}=L_{T}^{CPU,n}−L_{C}^{CPU,n}) is above a minimum threshold CPUₘᵢₙ (e.g., =R PLI)
MEM (L_{A}^{mem,n}=L_{T}^{mem,n}−L_{C}^{mem,n}) is above a minimum threshold MEMₘᵢₙ (e.g., =L_{R}^{mem})

CPUₘᵢₙ and MEMₘᵢₙ can be selected such that the nRT-RIC can provide a locally trained model within predefined delay budget. Values for CPUₘᵢₙ and MEMₘᵢₙ can be configured by an operator through SMO.

Candidate nRT-RICs can be selected based on similarity to existing clients' datasets:
IF the Euclidian distance E(.) is above a predefined threshold Eₘᵢₙ; for the ML model input features U and MCS, and the average number of users.
E(x,y) can be the Euclidian distance between datasets x and y=\sqrt{Σᵢ(xᵢ²−yᵢ²)}

$$E . g . , : E ( U ( i ) , U ( j ) ) = \sqrt{{( {U ( i )}_{min} - {U ( j )}_{min} )}^{2} + {( {U ( i )}_{max} - {U ( j )}_{max} )}^{2} + {( {U ( i )}_{median} - {U ( j )}_{median} )}^{2}}$$

Clients can be added that provide datasets with different ranges (e.g., larger Euclidian distance), which can avoid model overfitting.

Candidate nRT-RICs can be selected based on an average number of scheduled users:
The model can be expected to predict throughput for a predefined limit on the number of users.
Thus, nRT-RICs serving large number of users (e.g., above Nₘₐₓ) can be excluded from training to avoid model outliers.

FIG. 7 illustrates another example process flow that can facilitate client selection in open radio access network federated learning, in accordance with an embodiment of this disclosure. In some examples, one or more embodiments of process flow 700 can be implemented by client selection in open radio access network federated learning component 108 of FIG. 1, non-RT RIC 302 of FIG. 3, and/or computing environment 1600 of FIG. 16.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 200 of FIG. 2, process flow 600 of FIG. 6, process flow 800 of FIG. 8, process flow 900 of FIG. 9, process flow 1000 of FIG. 10, process flow 1100 of FIG. 11, process flow 1200 of FIG. 12, process flow 1300 of FIG. 13, process flow 1400 of FIG. 14, and/or process flow 1500 of FIG. 15.

Process flow 700 starts at 702, and moves to operation 704.

Operation 704 depicts evaluating each nRT-RIC j with the following operations.

After operation 704, process flow 700 moves to operation 706. Operation 706 depicts determining whether performance for the nRT-RICs is degraded. This can be indicated by a high RMSE.

Where it is determined that performance is degraded, process flow 700 moves to operation 708. Instead, where it is determined that performance is not degraded, process flow 700 ends. In some examples, process flow 700 ending after operation 706 can indicate that operation will continue with the current global machine learning model at least until another iteration of process flow 700 is performed. Process flow 700 can be periodically performed to determine whether to reselect FL clients.

Operation 708 is reached from operation 706 where it is determined that performance is degraded. Operation 708 depicts triggering candidate reselection. In some examples, candidate reselection can be performed in a similar manner as candidate selection in process flow 600 of FIG. 6.

After operation 708, process flow 700 moves to operation 710. Operation 710 depicts determining whether reselection produces the same set of clients as are currently being used for FL. Where in operation 710 it is determined that reselection produces the same set of clients as are currently being used for FL, process flow 700 moves to operation 712. Instead, where in operation 710 it is determined that reselection produces a different set of clients as are currently being used for FL, process flow 700 ends. Where process flow 700 ends after operation 710, the reselected candidates can be used for FL.

Operation 712 is reached from operation 710 where it is determined that reselection produces the same set of clients as are currently being used for FL. Operation 714 depicts increasing the minimum threshold values for Euclidian distance of U and M in reselecting clients. After operation 712, process flow 700 returns to operation 704, where operations 704-710 can again be performed using these new minimum threshold values, which can lead to a different set of clients being selected in operation 708.

During runtime, where the inference root mean square error (RMSE) at any of the non-client nRT-RIC increased (that is, ML model performance is degraded), then a candidate reselection process can be triggered. Additionally, IF the technique returns the same set of clients, then Euclidian distance thresholds can be increased to reflect a variance in datasets (and thus, more clients will be added in the selection process in the next iteration). Otherwise (ELSE), new candidates can be configured.

FIG. 8 illustrates another example process flow that can facilitate client selection in open radio access network federated learning, in accordance with an embodiment of this disclosure. In some examples, one or more embodiments of process flow 800 can be implemented by client selection in open radio access network federated learning component 108 of FIG. 1, non-RT RIC 302 of FIG. 3, and/or computing environment 1600 of FIG. 16.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 200 of FIG. 2, process flow 600 of FIG. 6, process flow 700 of FIG. 7, process flow 900 of FIG. 9, process flow 1000 of FIG. 10, process flow 1100 of FIG. 11, process flow 1200 of FIG. 12, process flow 1300 of FIG. 13, process flow 1400 of FIG. 14, and/or process flow 1500 of FIG. 15.

Process flow 800 begins with 802, and moves to operation 804. Operation 804 depicts determining a first group of near-real time radio access network intelligent controllers (nRT-RICs) of nRT-RICs of an open radio access network that satisfy a performance capability criterion. In some examples, this can comprise determining which nRT-RICs have available processing capabilities sufficient to perform federated learning. In the example of FIG. 1, this first group of nRT-RICs can be drawn from nRT-RIC 106A, nRT-RIC 106B, and nRT-RIC 106C.

After operation 804, process flow 800 moves to operation 806.

Operation 806 depicts determining, from the first group of nRT-RICs, a second group of nRT-RICs that satisfy a dissimilarity criterion, wherein the dissimilarity criterion identifies a dissimilarity between respective first datasets of respective first nRT-RICs of the first group of nRT-RICs and respective selected datasets of selected nRT-RICs of the nRT-RICs, wherein the selected nRT-RICs are selected for a current round of federated learning of a machine learning model. That is, of nRT-RICs that have processing capabilities sufficient to perform federated learning, a subgroup can be selected that have sufficiently different datasets to operate on. Using the example of FIG. 3, it can be determined that nRT-RIC 304A and nRT-RIC 304C are selected for the second group because they have sufficiently different datasets—the former being associated with region 1 310A, and the latter being associated with region 2 310B.

In some examples, the dissimilarity criterion is based on respective Euclidian distances between the respective first datasets the respective selected datasets. That is, a measure of Euclidian distance based on one or more metrics can be used to determine how similar or dissimilar two nRT-RICs are.

In some examples, respective first nRT-RICs of the first nRT-RICs correspond to respective regions of the open radio access network, and wherein the dissimilarity criterion measures overlap between the respective first datasets that corresponds to the respective regions. That is, there can be regions of a network, and some datasets can overlap. Using the example of FIG. 3, there is region 1 310A, and region 2 310B. These two regions (and therefore the corresponding datasets) overlap at the point of RU 308E, which is a member of both region 1 310A and region 2 310B.

After operation 806, process flow 800 moves to operation 808.

Operation 808 depicts instructing the second group of nRT-RICs to perform federated learning of the machine learning model on respective second datasets, to produce respective local machine learning models. That is, having selected the nRT-RICs that will perform the federated learning, these nRT-RICs can be instructed to perform federated learning.

After operation 808, process flow 800 moves to operation 810.

Operation 810 depicts, based on receiving respective indications of the respective local machine learning models, generating a global machine learning model based on the respective indications of the respective local machine learning models. That is, the nRT-RICs that are instructed to perform federated learning in operation 808 can report back their locally-generated machine learning models, and this can be used by non-RT RIC 102 (using the example of FIG. 1) to create a global machine learning model that incorporates information from the local models. In some examples, the indications of the respective local machine learning models can comprise weights for a neural network. This approach to federated learning can maintain privacy, where local machine learning models are reported, but not the underlying datasets used to create those local machine learning models.

After operation 810, process flow 800 moves to operation 812.

Operation 812 depicts sending an indication of the global machine learning model to the nRT-RICs, wherein the nRT-RICs are configured to use the global machine learning model to predict a network performance metric of the open radio access network. That is, in some examples, the global machine learning model can be distributed to all nRT-RICs, regardless of whether they participated in the federated learning to produce their version of a local machine learning model.

In some examples, this network performance metric is a data throughput.

After operation 812, process flow 800 moves to 814, where process flow 800 ends.

FIG. 9 illustrates another example process flow 900 that can facilitate client selection in open radio access network federated learning, in accordance with an embodiment of this disclosure. In some examples, one or more embodiments of process flow 900 can be implemented by client selection in open radio access network federated learning component 108 of FIG. 1, non-RT RIC 302 of FIG. 3, and/or computing environment 1600 of FIG. 16.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 200 of FIG. 2, process flow 600 of FIG. 6, process flow 700 of FIG. 7, process flow 800 of FIG. 8, process flow 1000 of FIG. 10, process flow 1100 of FIG. 11, process flow 1200 of FIG. 12, process flow 1300 of FIG. 13, process flow 1400 of FIG. 14, and/or process flow 1500 of FIG. 15.

Process flow 900 begins with 902, and moves to operation 904. Operation 904 depicts sending respective requests to respective third nRT-RICs of the nRT-RICs for respective processing capabilities of the respective third nRT-RICs. That is, as part of determining which nRT-RICs have processing capabilities suitable to perform federated learning, a non-RT RIC can request that the nRT-RICs report their processing capabilities.

After operation 904, process flow 900 moves to operation 906.

Operation 906 depicts receiving respective second indications of processing capabilities from the respective third nRT-RICs, wherein determining the first group of nRT-RICs that satisfy the performance capability criterion is based on the respective second indications of processing capabilities. That is, from all nRT-RICs queried in operation 904, those that have sufficient processing capabilities—that satisfy a performance capability criterion—can be selected for the first group.

In some examples, sending the respective requests and receiving the respective second indications is performed via an A1 interface of the open radio access network.

After operation 906, process flow 900 moves to 908, where process flow 900 ends.

FIG. 10 illustrates another example process flow 1000 that can facilitate client selection in open radio access network federated learning, in accordance with an embodiment of this disclosure. In some examples, one or more embodiments of process flow 1000 can be implemented by client selection in open radio access network federated learning component 108 of FIG. 1, non-RT RIC 302 of FIG. 3, and/or computing environment 1600 of FIG. 16.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 200 of FIG. 2, process flow 600 of FIG. 6, process flow 700 of FIG. 7, process flow 800 of FIG. 8, process flow 900 of FIG. 9, process flow 1100 of FIG. 11, process flow 1200 of FIG. 12, process flow 1300 of FIG. 13, process flow 1400 of FIG. 14, and/or process flow 1500 of FIG. 15.

Process flow 1000 begins with 1002, and moves to operation 1004. Operation 1004 depicts, after determining the first group of nRT-RICs, sending respective requests to respective first nRT-RICs of the first nRT-RICs for respective second indications of the respective first datasets. That is, after those nRT-RICs that have sufficient processing capabilities—that satisfy a performance capability criterion—can be selected for the first group.

After operation 1004, process flow 1000 moves to operation 1006.

Operation 1006 depicts receiving the respective second indications of the respective first datasets from the respective first nRT-RICs of the first nRT-RICs, wherein determining the second group of nRT-RICs is based on the respective second indications of the respective first datasets. That is, nRT-RICs can be selected for the second group based on determining that they have sufficiently dissimilar datasets, so that having them perform federated learning will cover a large amount of the total data across the respective datasets.

In some examples, sending of the respective requests and receiving the respective second indications is performed via an A1 interface of the open radio access network.

After operation 1006, process flow 1000 moves to 1008, where process flow 1000 ends.

FIG. 11 illustrates another example process flow 1100 that can facilitate client selection in open radio access network federated learning, in accordance with an embodiment of this disclosure. In some examples, one or more embodiments of process flow 1100 can be implemented by client selection in open radio access network federated learning component 118 of FIG. 1, non-RT RIC 302 of FIG. 3, and/or computing environment 1600 of FIG. 16.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 200 of FIG. 2, process flow 600 of FIG. 6, process flow 700 of FIG. 7, process flow 800 of FIG. 8, process flow 900 of FIG. 9, process flow 1000 of FIG. 10, process flow 1200 of FIG. 12, process flow 1300 of FIG. 13, process flow 1400 of FIG. 14, and/or process flow 1500 of FIG. 15.

Process flow 1100 begins with 1102, and moves to operation 1104. Operation 1104 depicts determining a first group of near-real time radio access network intelligent controllers (nRT-RICs) of nRT-RICs of a radio access network that satisfy a performance capability criterion. In some examples, operation 1104 can be implemented in a similar manner as operation 804 of FIG. 8.

After operation 1104, process flow 1100 moves to operation 1106.

Operation 1106 depicts determining, from the first group of nRT-RICs, a second group of nRT-RICs that satisfy a dissimilarity criterion, wherein the dissimilarity criterion identifies a dissimilarity between respective first datasets of respective first nRT-RICs of the first group of nRT-RICs and respective selected datasets of selected nRT-RICs of the nRT-RICs. In some examples, operation 1106 can be implemented in a similar manner as operation 806 of FIG. 8.

After operation 1106, process flow 1100 moves to operation 1108.

Operation 1108 depicts instructing the second group of nRT-RICs to perform federated learning, to produce respective local machine learning models. In some examples, operation 1108 can be implemented in a similar manner as operation 808 of FIG. 8.

After operation 1108, process flow 1100 moves to operation 1110.

Operation 1110 depicts, based on receiving respective indications of the respective local machine learning models, generating a global machine learning model. In some examples, operation 1110 can be implemented in a similar manner as operation 810 of FIG. 8.

After operation 1110, process flow 1100 moves to 1112, where process flow 1100 ends.

FIG. 12 illustrates another example process flow 1200 that can facilitate client selection in open radio access network federated learning, in accordance with an embodiment of this disclosure. In some examples, one or more embodiments of process flow 1200 can be implemented by client selection in open radio access network federated learning component 128 of FIG. 1, non-RT RIC 302 of FIG. 3, and/or computing environment 1600 of FIG. 16.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 200 of FIG. 2, process flow 600 of FIG. 6, process flow 700 of FIG. 7, process flow 800 of FIG. 8, process flow 900 of FIG. 9, process flow 1000 of FIG. 10, process flow 1100 of FIG. 11, process flow 1300 of FIG. 13, process flow 1400 of FIG. 14, and/or process flow 1500 of FIG. 15.

Process flow 1200 begins with 1202, and moves to operation 1204. Operation 1204 depicts detecting that an inference accuracy by the global machine learning model is below a defined inference accuracy specified by a performance criterion. That is, low inference accuracy can be detected.

In some examples, the respective indications are respective first indications, and operation 1204 comprises receiving respective second indications of inference accuracies from respective second nRT-RICs of the second nRT-RICs. That is, nRT-RICs can report their inference accuracy up to a non-RT RIC.

In some examples, the respective inference accuracies identify a root mean square error associated with operating the global machine learning model.

After operation 1204, process flow 1200 moves to operation 1206.

Operation 1206 depicts selecting a third group of nRT-RICs of the nRT-RICs with which to perform second federated learning for an update of the global machine learning model. That is, low inference accuracy can trigger reselection of nRT-RICs to perform federated learning. In some examples, reselection can be communicated via an A1 interface.

In some examples, operation 1206 comprises performing a metadata similarity between a first nRT-RIC that is outside of the second group of nRT-RICs and a second nRT-RIC of the second group of nRT-RICs, wherein the first nRT-RIC indicates an inference accuracy that is less than the defined inference accuracy specified by the performance criterion.

In some examples, operation 1206 comprises modifying a value of the dissimilarity criterion for selection of the third group of nRT-RICs of the nRT-RICs with which to perform the second federated learning for the update of the global machine learning model. That is, a dissimilarity criterion can be adapted in performing client reselection.

After operation 1206, process flow 1200 moves to 1208, where process flow 1200 ends.

FIG. 13 illustrates another example process flow 1300 that can facilitate client selection in open radio access network federated learning, in accordance with an embodiment of this disclosure. In some examples, one or more embodiments of process flow 1300 can be implemented by client selection in open radio access network federated learning component 138 of FIG. 1, non-RT RIC 302 of FIG. 3, and/or computing environment 1600 of FIG. 16.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 200 of FIG. 2, process flow 600 of FIG. 6, process flow 700 of FIG. 7, process flow 800 of FIG. 8, process flow 900 of FIG. 9, process flow 1000 of FIG. 10, process flow 1100 of FIG. 11, process flow 1200 of FIG. 12, process flow 1400 of FIG. 14, and/or process flow 1500 of FIG. 15.

Process flow 1300 begins with 1302, and moves to operation 1304. Operation 1304 depicts determining a fourth group of nRT-RICs that satisfy the performance capability criterion. That is, those nRT-RICs that satisfy the performance capability criterion can be predetermined as part of client reselection.

After operation 1304, process flow 1300 moves to operation 1306.

Operation 1306 depicts selecting the third group of nRT-RICs is based on the fourth group of nRT-RICs. That is, those clients that will be used to perform federated learning can be selected from the reselected group of clients that satisfy the performance capability criterion

After operation 1306, process flow 1300 moves to 1308, where process flow 1300 ends.

FIG. 14 illustrates another example process flow 1400 that can facilitate client selection in open radio access network federated learning, in accordance with an embodiment of this disclosure. In some examples, one or more embodiments of process flow 1400 can be implemented by client selection in open radio access network federated learning component 148 of FIG. 1, non-RT RIC 302 of FIG. 3, and/or computing environment 1600 of FIG. 16.

It can be appreciated that the operating procedures of process flow 1400 are example operating procedures, and that there can be embodiments that implement more or fewer operating procedures than are depicted, or that implement the depicted operating procedures in a different order than as depicted. In some examples, process flow 1400 can be implemented in conjunction with one or more embodiments of one or more of process flow 200 of FIG. 2, process flow 600 of FIG. 6, process flow 700 of FIG. 7, process flow 800 of FIG. 8, process flow 900 of FIG. 9, process flow 1000 of FIG. 10, process flow 1100 of FIG. 11, process flow 1200 of FIG. 12, process flow 1300 of FIG. 13, and/or process flow 1500 of FIG. 15.

Process flow 1400 begins with 1402, and moves to operation 1404. Operation 1404 depicts, in response to determining that the third group of nRT-RICs matches the second group of nRT-RICs, adjusting a value of the dissimilarity criterion to produce an adjusted dissimilarity criterion. That is, in some examples, reselection can return a same set of clients as before. In such cases, a Euclidian distance threshold used in the dissimilarity criterion can be increased to reflect a variance in datasets (and thus, it can be that more clients are added in the selection process in a next iteration).

After operation 1404, process flow 1400 moves to operation 1406.

Operation 1406 depicts selecting, based on the adjusted dissimilarity criterion, a fourth group of nRT-RICs of the nRT-RICs with which to perform the second federated learning for the update of the global machine learning model. That is, the clients that will be used for federated learning can be selected from this third group of operation 1404.

After operation 1406, process flow 1400 moves to 1408, where process flow 1400 ends.

FIG. 15 illustrates another example process flow 1500 that can facilitate client selection in open radio access network federated learning, in accordance with an embodiment of this disclosure. In some examples, one or more embodiments of process flow 1500 can be implemented by client selection in open radio access network federated learning component 158 of FIG. 1, non-RT RIC 302 of FIG. 3, and/or computing environment 1600 of FIG. 16.

It can be appreciated that the operating procedures of process flow 1500 are example operating procedures, and that there can be embodiments that implement more or fewer operating procedures than are depicted, or that implement the depicted operating procedures in a different order than as depicted. In some examples, process flow 1500 can be implemented in conjunction with one or more embodiments of one or more of process flow 200 of FIG. 2, process flow 600 of FIG. 6, process flow 700 of FIG. 7, process flow 800 of FIG. 8, process flow 900 of FIG. 9, process flow 1000 of FIG. 10, process flow 1100 of FIG. 11, process flow 1200 of FIG. 12, process flow 1300 of FIG. 13, and/or process flow 1400 of FIG. 14.

Process flow 1500 begins with 1502, and moves to operation 1504. Operation 1504 depicts determining a first group of agents from agents of a communications network that satisfy a performance capability criterion. In some examples, operation 1504 can be implemented in a similar manner as operation 804 of FIG. 8. In some examples, the agents can be nRT-RICs.

After operation 1504, process flow 1500 moves to operation 1506.

Operation 1506 depicts determining, from the first group of agents, a second group of agents that satisfy a dissimilarity criterion based on respective metadata of respective agents of the first group of agents. In some examples, operation 1506 can be implemented in a similar manner as operation 806 of FIG. 8.

In some examples, the respective metadata of respective agents of the agents comprises statistics about respective datasets of the respective agents, the statistics comprising at least one of a throughput, a retainability, or an accessibility. In some examples, the metadata can comprise a statistic about data collection granularity.

After operation 1506, process flow 1500 moves to operation 1508.

Operation 1508 depicts instructing the second group of agents to perform federated learning, to produce respective local machine learning models. In some examples, operation 1508 can be implemented in a similar manner as operation 808 of FIG. 8. After operation 1508, process flow 1500 moves to operation 1510.

Operation 1510 depicts, based on receiving respective indications of the respective local machine learning models, generating a machine learning model based on the respective local machine learning models. In some examples, operation 1510 can be implemented in a similar manner as operation 810 of FIG. 8.

In some examples, operation 1510 comprises deploying the machine learning model to a first agent of the agents, wherein the first agent is separate from the second group of agents. In some examples, it can be that federated learning is performed on a subset of agents, and then the global machine learning model can be distributed to all agents.

In some examples, an input to the machine learning model comprises an indication of network utilization metrics. In some examples, this indication can regard a physical resource block utilization, or a modulation and coding scheme.

In some examples, an output of the machine learning model comprises an indication of mean user equipment throughput.

After operation 1510, process flow 1500 moves to 1512, where process flow 1500 ends.

### Example Operating Environment

In order to provide additional context for various embodiments described herein, FIG. 16 and the following discussion are intended to provide a brief, general description of a suitable computing environment 1600 in which the various embodiments of the embodiment described herein can be implemented.

For example, parts of computing environment 1600 can be used to implement one or more embodiments of non-RT RIC 102, communications network 104, nRT-RIC 106A, nRT-RIC 106B, and/or nRT-RIC 106C of FIG. 1.

In some examples, computing environment 1600 can implement one or more embodiments of the process flows of FIGS. 2 and 6-15 to facilitate client selection in open radio access network federated learning.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a nonvolatile storage such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1694 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a processor; and
a memory coupled to the processor, comprising instructions that cause the processor to perform operations comprising:
determining a first group of near-real time radio access network intelligent controllers (nRT-RICs) of nRT-RICs of an open radio access network that satisfy a performance capability criterion;
determining, from the first group of nRT-RICs, a second group of nRT-RICs that satisfy a dissimilarity criterion, wherein the dissimilarity criterion identifies a dissimilarity between respective first datasets of respective first nRT-RICs of the first group of nRT-RICs and respective selected datasets of selected nRT-RICs of the nRT-RICs, wherein the selected nRT-RICs are selected for a current round of federated learning of a machine learning model;
instructing the second group of nRT-RICs to perform federated learning of the machine learning model on respective second datasets, to produce respective local machine learning models;
based on receiving respective indications of the respective local machine learning models, generating a global machine learning model based on the respective indications of the respective local machine learning models; and
sending an indication of the global machine learning model to the nRT-RICs, wherein the nRT-RICs are configured to use the global machine learning model to predict a network performance metric of the open radio access network.

2. The system of claim 1, wherein the respective indications are respective first indications, and wherein the operations further comprise:
sending respective requests to respective third nRT-RICs of the nRT-RICs for respective processing capabilities of the respective third nRT-RICs; and
receiving respective second indications of processing capabilities from the respective third nRT-RICs,
wherein determining the first group of nRT-RICs that satisfy the performance capability criterion is based on the respective second indications of processing capabilities.

3. The system of claim 2, wherein sending the respective requests and receiving the respective second indications is performed via an A1 interface of the open radio access network.

4. The system of claim 1, wherein the respective indications are respective first indications, and wherein the operations further comprise:
after determining the first group of nRT-RICs, sending respective requests to respective first nRT-RICs of the first nRT-RICs for respective second indications of the respective first datasets; and
receiving the respective second indications of the respective first datasets from the respective first nRT-RICs of the first nRT-RICs,
wherein determining the second group of nRT-RICs is based on the respective second indications of the respective first datasets.

5. The system of claim 4, wherein sending of the respective requests and receiving the respective second indications is performed via an A1 interface of the open radio access network.

6. The system of claim 1, wherein the dissimilarity criterion is based on respective Euclidian distances between the respective first datasets the respective selected datasets.

7. The system of claim 1, wherein respective first nRT-RICs of the first nRT-RICs correspond to respective regions of the open radio access network, and wherein the dissimilarity criterion measures overlap between the respective first datasets that corresponds to the respective regions.

8. A method, comprising:
determining, by a system comprising a processor, a first group of near-real time radio access network intelligent controllers (nRT-RICs) of nRT-RICs of a radio access network that satisfy a performance capability criterion;
determining, by the system and from the first group of nRT-RICs, a second group of nRT-RICs that satisfy a dissimilarity criterion, wherein the dissimilarity criterion identifies a dissimilarity between respective first datasets of respective first nRT-RICs of the first group of nRT-RICs and respective selected datasets of selected nRT-RICs of the nRT-RICs;
instructing, by the system, the second group of nRT-RICs to perform federated learning, to produce respective local machine learning models; and
based on receiving respective indications of the respective local machine learning models, generating, by the system, a global machine learning model.

9. The method of claim 8, wherein the federated learning is first federated learning, and further comprising:
in response to detecting that an inference accuracy by the global machine learning model is below a defined inference accuracy specified by a performance criterion, selecting, by the system, a third group of nRT-RICs of the nRT-RICs with which to perform second federated learning for an update of the global machine learning model.

10. The method of claim 9, wherein the respective indications are respective first indications, and wherein detecting that the inference accuracy by the global machine learning model is below the defined inference accuracy specified by the performance criterion comprises:
receiving respective second indications of inference accuracies from respective second nRT-RICs of the second nRT-RICs.

11. The method of claim 10, wherein the respective inference accuracies identify a root mean square error associated with operating the global machine learning model.

12. The method of claim 9, wherein selecting the third group of nRT-RICs of the nRT-RICs with which to perform the federated learning for the update of the global machine learning model comprises:
performing, by the system, a metadata similarity between a first nRT-RIC that is outside of the second group of nRT-RICs and a second nRT-RIC of the second group of nRT-RICs, wherein the first nRT-RIC indicates an inference accuracy that is less than the defined inference accuracy specified by the performance criterion.

13. The method of claim 9, further comprising:
modifying, by the system, a value of the dissimilarity criterion for selection of the third group of nRT-RICs of the nRT-RICs with which to perform the second federated learning for the update of the global machine learning model.

14. The method of claim 9, further comprising:
determining, by the system, a fourth group of nRT-RICs that satisfy the performance capability criterion,
wherein selecting the third group of nRT-RICs is based on the fourth group of nRT-RICs.

15. The method of claim 9, further comprising:
in response to determining that the third group of nRT-RICs matches the second group of nRT-RICs, adjusting, by the system, a value of the dissimilarity criterion to produce an adjusted dissimilarity criterion; and
selecting, by the system and based on the adjusted dissimilarity criterion, a fourth group of nRT-RICs of the nRT-RICs with which to perform the second federated learning for the update of the global machine learning model.

16. A non-transitory computer-readable medium comprising instructions that, in response to execution, cause a system comprising a processor to perform operations, comprising:
determining a first group of agents from agents of a communications network that satisfy a performance capability criterion;
determining, from the first group of agents, a second group of agents that satisfy a dissimilarity criterion based on respective metadata of respective agents of the first group of agents;
instructing the second group of agents to perform federated learning, to produce respective local machine learning models; and
based on receiving respective indications of the respective local machine learning models, generating a machine learning model based on the respective local machine learning models.

17. The non-transitory computer-readable medium of claim 16, wherein the operations further comprise:
deploying the machine learning model to a first agent of the agents, wherein the first agent is separate from the second group of agents.

18. The non-transitory computer-readable medium of claim 16, wherein an input to the machine learning model comprises an indication of network utilization metrics.

19. The non-transitory computer-readable medium of claim 16, wherein an output of the machine learning model comprises an indication of mean user equipment throughput.

20. The non-transitory computer-readable medium of claim 16, wherein the respective metadata of respective agents of the agents comprises statistics about respective datasets of the respective agents, the statistics comprising at least one of a throughput, a retainability, or an accessibility.
